(19) United States
(12) Patent Application Publication
(10) Pub. No.: US 2008/0216023 A1
(43) Pub. Date: Sep. 4, 2008

(54) Method and a system for creating a website guide

(75) Inventors: Erik Berglund, Linkoping (SE); Magnus Bang, Linkoping (SE); Anders Larsson, Linghem (SE)

Correspondence Address: VENABLE LLP, P.O. BOX 34385, WASHINGTON, DC, 20043-9998, US

(73) Assignee: Omnitus AB, Linkoping (SE)

(21) Appl. No.: 11/712,982

(22) Filed: Mar. 2, 2007

(51) Int. Cl. G06F 3/048

(52) U.S. Cl. 715/855; 715/709

(57) ABSTRACT

A method and a system for creating a website guide assisting in finding information on a website. A guide editor includes information on how to generate a graphical user interface allowing a user to specify a page on the website, and instructions on how to generate a view showing a graphical input object superimposed on the specified page on the website allowing a first person to enter links to selected information on the website. A first computer device includes a first graphical generator adapted to generate and display the graphical user interface and the view. Data storage stores guide data including an address to the specified page on the website, links to the selected information, and instructions on how to create a website guide in response to a request from a second person. The website shows a graphical message object superimposed on the specified page of the website. The graphical message object includes link elements which, upon activation, display the selected information on the website. An access generator generates information in a format readable by a web browser on how to access the stored guide data.

### FIELD OF THE INVENTION

The present invention relates to a method and a system for creating a website guide for assisting a person to find selected information on a website.

### PRIOR ART

A website is a collection of web pages, typically common to a particular domain name or sub domain on the World Wide Web on the Internet. A website is hosted on a computer system called a web server. A web server is a physical computer unit and software that retrieves and delivers the web pages in response to requests from website users. When a web server receives a request for a given page, the page is automatically retrieved from data storage by the software in response to the page request. The websites are accessed using a software program called a web browser. A web page is a document, typically written in HTML, which is accessible via a protocol that transfers information from the website server to the user's computer and is displayed in the user's web browser. When a user requests a view from a page on the website, information from the website server is transferred to the user's computer which is provided with a web browser. The web browser of the user displays the page on the screen of the users computer. All pages of a website can be accessed from a common page, called a home page, which usually reside on the same physical server as the other pages of the website. A website can contain a hyperlink to other websites. Web pages can be viewed from computers and other Internet enabled devices via the Internet. Examples of Internet enabled devices are desktop computers, laptop computers, PDA-s and cellular telephones.

A trend today is an increasing size of the websites. However, the large amount of information and the large number of pages on the websites sometimes makes it difficult for a person not familiar with the website to find relevant information on the website. Sometimes a website also provides interactive pages which can be difficult to use for a person without specialist knowledge. A website is often owned by a company or an authority, having employees who are familiar with the website and have knowledge about where to find relevant information on the website, and therefore have the possibility to help a person, such as a client or a customer, to find requested information.

Today, it is possible for a first person to transfer information from a website to a second person by copying information from the website and past it into an email, or a similar electronic communication means, such as an instant messaging system. In e-mail communications, when sending links with references to resources on a website, there is no guarantee that the second person will see the website. Sending links to PDF-files, the e-mail client will open the PDF-file directly. The fist person may copy and paste the information directly or hyperlinks to specific pages on the website. However, this information is taken out of its context and is shown in a separate system without the rest of the content provided by the website. The information will in fact be distorted, when sent in a separate system, which has its own implementation of how the information is shown to the receiver, both when loosing its context and when copying small amounts of information that becomes quotes out of their original context. Therefore, there is a need for an improved method and system for assisting a person to find selected information on a website.

### OBJECTS AND SUMMARY OF THE INVENTION

An object of embodiments of the present invention is to provide a solution, which alleviates the problems mentioned above, and which provides a website guide which makes it easy and safe for a first person to assist a second person on how to find relevant information on a website.

According to one aspect of the invention this object is achieved by a method, one embodiment of which includes receiving an address specifying a page on the website, generating a view showing a graphical input object superimposed on the specified page of the website allowing a first person to move around on the website and to enter links to selected information on the website, receiving the links to the selected information on the website, generating instructions on how to create a website guide in response to a request from a second person, showing a graphical message object superimposed on the specified page of the website, which graphical message object includes link elements which upon activation displays the selected information on the website, storing guide data including the address to the specified page on the website, the links to the selected information, and the instructions on how to create a website guide, and generating information on how to access the guide data in a format readable by a web browser.

Typically, the first person is a person familiar with the website having knowledge of where to find specific information on the website, and the second person is a person who needs guiding on how to find relevant information on the website. The first step in the method is that the first person specifies a page on the website, which will be the start page of the guiding. The specified page can be the home page of the website, or any other page of the website. A view showing a graphical input object superimposed on the specified page of the website is displayed to the first person. Thereafter, the first person may move around in the website and enter links to information, which is relevant to the second person, to the graphical input object. The information can be selected from any page of the website. For example, the links to the selected information are entered to the graphical input object by copy and paste, or drag and drop techniques.

The address to the start page and the links are stored together with instructions on how to display this information to the second person as guide data. Information on how to access the guide data is generated and transferred to the second person. Typically, the information of how to access the guide data is automatically communicated to the second person, for example, by an email, or an SMS. However, the access information can also be orally communicated to the second person, for example by a telephone call or a letter.

When the second person has received information on how to access the guide data, the second person may load the guide data and thereby generate a personal website guide showing the start page and a graphical message object superimposed on the page, which graphical message objects includes link elements that upon activation display the selected information on the website. The link elements are, for example, activated by a mouse click. The link elements displayed on the graphical messages object are, for example, text strings including links to the selected information on the website.

Embodiments of the invention may enable a first person to create and provide a second person with a personal website guide pointing out selected information in an existing website. Embodiments of the invention may make it possible to guide another person on a website without distorting the information, and keeping the information in the original context of the website. The selected information may be shown directly in the web page and thereby the information is kept in its original context. According to some embodiments of the invention, the website and the guide content, i.e. the link elements, are shown together in the same view. A personal message object including the link elements, which upon activation displays the selected information, is superimposed on the website to pinpoint relevant information on the website. Embodiments of the invention may make it easy for a person to compose a personal website guide to another person. As the information on how to access the guide data is generated in a format readable by a web browser, the website guide is easily accessible by means of a web browser. Most modern computers are provided with a web browser, and thus no extra software has to be installed in order to access the website guide. The software necessary for creating and displaying the website guide is completely separated from the software handling the website guide. Thus, another advantage with the invention is that the website is uninfluenced by the creation of a website guide.

According to some embodiments of the invention, the guide is superimposed on the website when viewed by the second person. This will ensure and increase the exposure of the website to the second person as part of everyday personal communication. A personal guide is handled by a combination of a guide and website content accessible via a web browser. This provides the first and second person with a more secure personal communications technology than e-mail. E-mail does not ensure that an apparent sender actually sent the message. The domain-name service on the Internet, however, ensures that the correct web page is received. Furthermore e-mail does not guarantee the first person to know that the second person has viewed the personal guide, which the present invention does. Even more so, sending links to documents as attachments in e-mail is a potential security problem, where as web browsers commonly ensure that viewed web pages cannot harm the second person's computer. According to some embodiments of the invention, a personal guide is created superimposing guide data on the website. This enables a more graphically advanced and controlled personal communication compared to e-mail, where e-mail clients may only provide text-based messages.

According to an embodiment of the invention, the guide data is generated in a format readable by a web browser. This enables a user to display the website guide by means of a web browser in his own computer. Thereby, no extra software needs to be installed in the computer for displaying the website guide. Ordinary people are also familiar with how to use a web browser. Another advantage of providing the guide data in a form readable by a web-browser is that other application developers may integrate the invention simply by providing web-browser functionality in their applications.

According to another embodiment of the invention, the view displayed to the first person shows the graphical input object floating on top of the specified page on the website, and the website guide displayed to the second person shows the graphical message object floating on top of the specified page. This embodiment makes it possible to move around the graphical objects on the screen thereby preventing them to hide information on the page. It is also possible to move the graphical objects so that only a part of the object is visible on the display screen and the rest of the object is hidden. This also enables the use of the invention inside an existing web browser, making it easier to create and view personal guides because only one application window, i.e. the web browser, needs to be active. Navigation among several application windows is eliminated, and thereby the efficiency of the steps involved is increased. It also means that the guide editor is loaded very rapidly, when using the web browser in general.

According to a further embodiment of the invention, the view displayed to the first person allows the first person to enter a link to a selected piece of information on a selected page of the website, and the method further includes generating upon activation of one of the link elements a third view showing the selected page of the website and a graphical highlighting element superimposed on the selected piece of information on the web page. This embodiment makes it possible for a second person to highlight certain sentences, paragraphs, images, multimedia objects, hyperlinks, or screen coordinates on a web page, which is particularly important, and makes it possible for the second person to view the whole page including the highlighted parts of the page. In such a way the interesting information is kept in its context, in contrary to if a cut and paste technique has been used and only the relevant part of the information has been sent to the first person. It also becomes possible to guide a second person by using individual parts of a web page.

According to an embodiment of the invention, the information on how to access the guide data includes an address defining a web page containing the guide data. Preferably, the address to the guide data is a Uniform Resource Identifier/Uniform Resource Locator (URI/URL). An URI/URL is a web address readable by a web browser. This embodiment makes it easy for the second person to find the guide data and read it by means of a web browser.

According to an embodiment of the invention, the information on how to access the guide data includes an address defining a web page containing the guide data and a code to be input to an interactive object in the web page. The use of a code for access of the invention increases the security if the information should be kept secret. This is, for example, useful if information from patient diaries is transferred. It also enables the use of access information that is easy to input for the second person. Furthermore, it enables the communication of access information in more than one form, such as sending and e-mail with the URL and providing the code orally.

According to another embodiment of the invention, the method may further include including in the guide data, input data entered by the first person to a selected page on the website, and including a link element in the graphical message object, which link object upon activation automatically enters the input data to the selected web page. This embodiment enables the first person to help the second person to use interactive services on the website, for instance by partially filling in forms without requiring any alteration of the website.

It is easy to realize that certain embodiments of the method according to the invention, are suitable for execution by a computer program having instructions corresponding to the steps in the inventive method with one or more processor units.

According to a further aspect of the invention, the object is achieved by a computer program product directly loadable into the internal memory of a computer or a processor, including software code positions for performing the steps of the method according to the appended set of method claims, when the product is run on a computer. The computer program is provided either on a computer readable medium or through a network, such as the Internet.

According to another aspect of the invention, the object is achieved by a computer readable medium having a program recorded thereon, when the program is to make a computer perform the steps of the method according to the appended set of method claims, and the program is run on the computer.

According to another aspect of the invention this object is achieved by a system that includes a guide editor including information on how to generate a graphical user interface allowing a user to specify a page on the website, and instructions on how to generate a view showing a graphical input object superimposed on the specified page on the website allowing a first person to enter links to selected information on the website, a first computer device including a first graphical generator adapted to generate and display the graphical user interface and the view upon loading the guide editor, a data storage for storing guide data including an address to the specified page on the website, links to the selected information, and instructions on how to create a website guide in response to a request from a second person, the website guide showing a graphical message object superimposed on the specified page of the website, which graphical message object includes link elements which upon activation displays the selected information on the website, an access generator generating information in a format readable by a web browser on how to access the stored guide data, and a second computer device including a web browser adapted to generate the website guide upon access of the guide data.

According to an embodiment of the invention the system includes a first server hosting the website, and a second server hosting the readable guide editor and the data storage for storing guide data, wherein the first and second servers are separately arranged. A server is a physical computer unit and software that retrieves and delivers data in response to requests from a user. According to this embodiment, the guide editor and the guide data storage are stored on a server, which is not the web server-hosting the website. This is an advantage since the company providing the guide service is often not the same as the company providing the website. It also enables the use of the service without any change or installation of software on the website web server.

### BRIEF DESCRIPTIONS OF THE DRAWINGS

The invention will now be explained more closely by the description of different embodiments of the invention and with reference to the appended figures.

FIG. 1 shows a system for creating a website guide according to an embodiment of the invention.

FIG. 2 shows an example of a view of a graphical input object superimposed on a page on a website.

FIG. 3 shows an example of a view showing a graphical message object superimposed on a page of a website.

FIG. 4 shows an example of a view showing a graphical highlighting object superimposed on a selected piece of information on a web page.

FIG. 5 is a flow chart of a method for creating a website guide according to an embodiment of the invention.

FIG. 6 is a flow chart showing what occurs upon access of the guide data.

### DETAILED DESCRIPTION OF PREFERRED EMBODIMENTS OF THE INVENTION

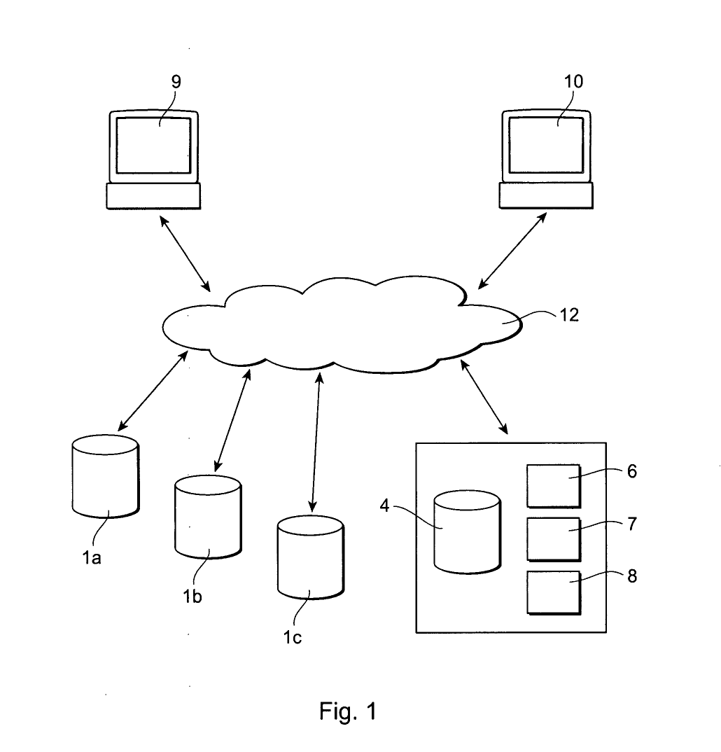

FIG. 1 shows an embodiment of a system for creating a website guide according to an embodiment of the invention. This embodiment of the system includes a plurality of website servers 1a-c having hardware and software for running different websites, a guide server 2 including a guide data storage in the form of a database 4 for storing guide data, a guide editor 6, and an access generator 7 generating information on how to access the stored guide data. The guide database 4 is adapted for storing guide data including user information, such as an address to a specified page on the website and links to selected information, and guide usage information including instructions on how the stored information is to be displayed.

The guide editor 6 includes instructions to, for example a web browser, on how to generate a graphical user interface allowing a user to specify a start page on a website on any of the website servers, how to generating a view showing a graphical input object superimposed on the specified page of the website allowing a first person to navigate on the website and to enter links to selected information on the website. The guide editor is, for example, a web page providing necessary media and programmatic instructions to a web browser to generate the graphical user interface, to create graphical input objects on top of an existing websites, allowing a user to enter links to select the information on the website, for viewing the graphical input object superimposed on an existing page on the website, for combining guide data with website content, and for handling partial interactivity with interactive services on the web page.

The access generator 7 is adapted to generate information on how to access stored guide data upon storing the guide data. The access information is generated in a format readable by a web browser. Formats are identified in the HTTP protocol using a MIME content type. Examples of formats readable by a web browser include HTML, XML, CSS, DOM, JavaScript, JScript, VBScript, AU, WAV, MID, PNG, GIF, JPG, BMP, XHTML, SVG, SWF, SMIL, AVI, MPG, MP3, MOV. Optionally, the access generator includes software for providing communication services between a first person, in the following called a sender, and a second person, in the following called a receiver, in the website guide.

A start page is defined for the guide editor. The start page for the guide does not have to be the same as the start page for the website. As the guide data is loaded by the receiver, it is loaded with a start page, which may be the website start page or a web page that can be found on the website. The guide editor receives the address to the start page from the sender who may enter it either by printing the address or copy/paste, or drag/drop. The guide editor navigates on the website until the appropriate start page is found and identified as the start page for the guide editor.

Once the start page is defined, the system accepts links, such as hyperlinks, which are identified as resources, for instance, by selecting and drag/dropping hyperlinks from web pages that the sender has located. The sender selects and copies hyperlinks in the website and paste them into the input object floating on top of the website. This enables the sender to create website guides using the content of the website as provided by the website server. Once a guide has been created it has to be stored for access by the receiver. The guide editor sends the guide data to the guide database where it is stored. Optionally, the system also includes a communicating means 8 adapted to automatically communicate information on how to access the guide data to the receiver, for example by means of an e-mail, SMS, MMS, an instant message, or Internet relay chat. However, it is also possible to orally communicate the access information over a phone, person to person, or by printed letters.

In an alternative embodiment, the guide server 2 may be a part of the website server hosting the website on which the guiding is to be performed. Thus, the guide database 4, the guide editor 6 and the access generator 7 may be integrated in the website server. In this case, the guide software runs alongside with the website content data, but does not require alternations to the web pages on the web server.

The system may further include a sender computer device 9 including a graphical generator adapted to generate and display the graphical user interface and the view showing the graphical input object superimposed on the website, upon loading the guide editor. The sender computer device 9 may be used by a sending person to create website guides to a receiving person. The sender computer device can be any type of Internet connected device, preferably with a web browser software installed, such as a desktop computer, a laptop, a media server, a TV box, a cellular phone, or a handheld computer device. The sender computer device 9 may also have special purpose software downloaded for enabling the creation of the website guide without using a web browser, but requiring access to the content of the website server. In an alternative embodiment, the guide database 4, the guide editor 6, and the access generator 7 can be stored on the sender computer device 9.

The system may further include a receiver computer device 10 including a web browser for generating upon access of the guide data, a view showing a graphical message object superimposed on the start page of the website, which graphical message object includes elements, which upon activation displays the selected information of the website. The receiver computer device 10 may be used to access the guide data, and can be any type of Internet connected device having a web browser software installed, such as a desktop computer, a laptop, a media server, a TV box, a cellular phone, or a handheld computer device. The system also includes a network 12 connecting the devices and servers. The network is, for example the Internet, an Intranet or a GSM network.

The system may include the following software programs:

A guide database management system, which is software used to manage and store the guide data.

A guide editor, which is software used to create the graphical user interface and the view showing the graphical input object superimposed on a specified web page based on data from the website.

A guide access code generator, which is software for creating access codes used to access the stored guide data. The code is either a unique URL/URI identifying a combination of a graphical message object and a specified website, or login information used in an interactive form on a web page on the Internet. This editor may have special quick editors, for instance, for mobile phones where a prepared process of creating guides from stored templates are used to increase the speed with which a guide is created.

A guide access communicator, which is software for communicating access codes to receivers, such as an e-mail client, a SMS or a MMS sender, an instant messenger, Internet relay chat, a phone system or an IP phone system.

A guide viewer, which is software needed to view the combined website and graphical input object or message object.

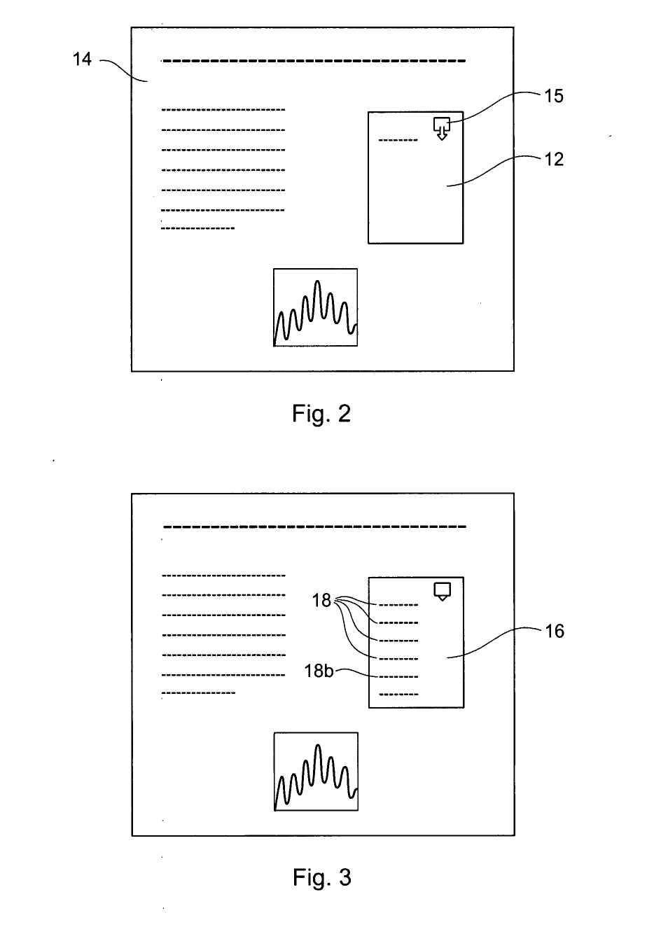

FIG. 2 shows an example of a view showing a graphical input object 12 superimposed on a web page 14 displayed on the sender computer device 9. The graphical input object 12 is provided with an empty space for receiving links to selected information on the website. The graphical input object may also be provided with a text string. The user may navigate in the website and visit different web pages as desired, and when the user finds interesting information on a web page, a link to the page with the information, is entered to the input object 12, for example by cut and paste of the link, or by drag an drop of the link. The user may also enter links to text or figures in a web page to the input object. Accordingly, the empty space is filled with links to selected pages on the website. It is also possible for the user to delete links, which have been put to the input object if he regrets the input of the link.

The graphical input object 12 is floating on top of the displayed website. It is possible to move around the input object on the top of the presently displayed web page, so that the input object does not hide information displayed on the web page. The graphical input object is provided with a “hide” button 15. When the “hide” button is activated by, for example a mouse click, the graphical input object is partially hidden and thereby is out of the way so that the user can read everything on the displayed web page. The “hide” button 15 is still shown on the screen when the input object is hidden, and when the user activates the “hide” button again the graphical input object pops up again and is displayed on top of the web page.

FIG. 3 shows a view displayed on the receiver computer device showing a graphical message object 16 superimposed on the specified start page of the website. The graphical message object 16 includes a plurality of link elements 18, which upon activation displays the information on the website selected by the sender. The link elements 18 are, for example, displayed as a text string or as a graphical symbol. A link element can also include a link to a selected piece of information, or to a particular web page on the website. According to an embodiment of the invention, guide data includes input data entered by the sender on a selected page on the website, and the graphical message object including a link element 18b, which upon activation automatically enters the input data entered by the first person to the selected web page.

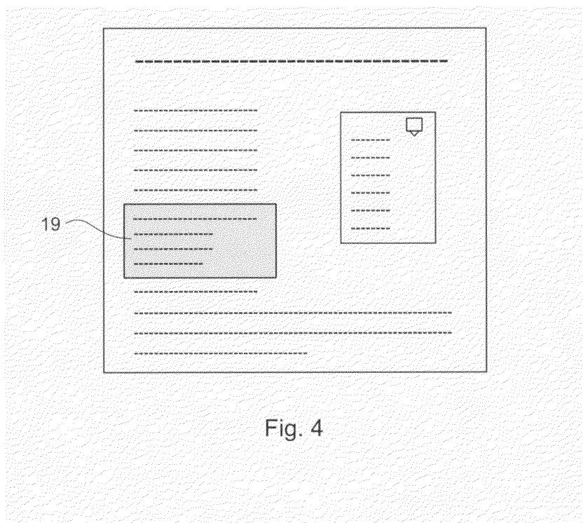

FIG. 4 shows an example of a view showing a graphical highlighting object 19 superimposed on a selected piece of information on a web page. According to an embodiment of the invention, the guide editor is provided with software that allows the sender to provide a link, to a selected piece of information on the website, with information on that the selected piece of information shall be highlighted when it is displayed to the receiver. The website guide shows upon activation of such a link elements a view showing the graphical highlighting object 19 superimposed on the selected piece of information on the web page.

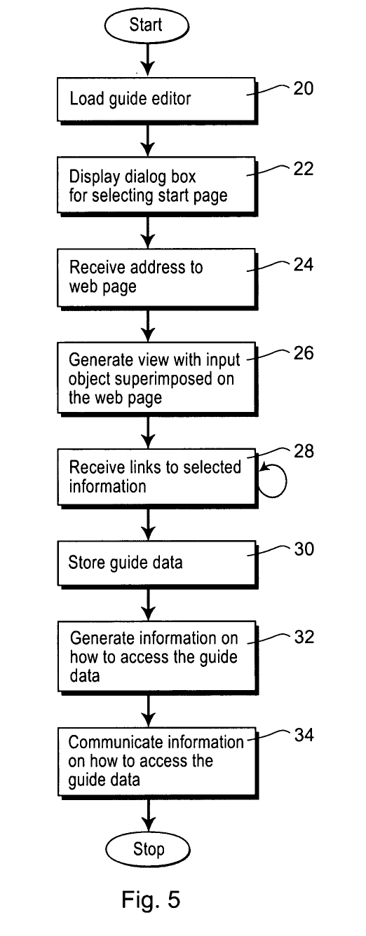

FIG. 5 is a flow chart illustration of a method and computer program product according to an embodiment of the present invention. It will be understood that each block of the flow chart can be implemented by computer program instructions.

When a sender wants to create a website guide, a guide editor is loaded from the guide web server 2 to the sender computer device 9, box 20. If the guide editor is already installed on the sender computer device 9, the guide editor does not need to be loaded. The guide editor is started. When the guide editor has been started, a dialogue box is shown to the sender, requesting the sender to specify a start page on a website, box 22. The sender enters an address specifying a page on the website, for example, the home page of the website. If the address to the website is specified, the home page of the website is taken as a default start page.

The guide editor receives the address to the specified start page, block 24. Upon receiving the address to the start page, the guide editor instructs the web browser to load the start page from the web server to the sender computer device. The guide editor instructs the web browser how to show a graphical input object superimposed on the start page, block 26.

The sender navigates through the web server and copies links to interesting parts of the website and pastes the links to the selected information to the graphical input object, block 28. Of course, when the sender moves around in the website, other pages of the website are displayed in dependence on requests from the sender, and the graphical input object is superimposed on the presently displayed web page.

When the sender has been finished, guide data is generated and stored in the guide database 4, block 30. The guide data includes information on the specified start web page, the links entered to the graphical input object, and instructions on how this information is to be displayed to the receiver. Thereafter guide access information is created, such as a guide URL, which is either a URL, or a combination of an URL and a code, block 32. The code may be split into an id and a password. Using the guide access information, the receiver should be able to load the guide data from the guide database and the website from the website server. Stored guide data has to be accessible by the receiver using a web browser over a network, such as the Internet. The system must therefore connect a guide data to a guide URL, by connecting a new guide URL, which may be done by using an URL and creating a new code, or registering an existing code with a new URL. The system must be able to accept proposed data when constructing a guide URL. For instance, using a code provided by the sender in an interactive object in a web page, and creating a guide URL that contains that code.

In order to provide the receiver with the guide access information, the sender needs to communicate the guide access information to the receiver, block 34. The system must therefore be able to transfer the guide access information to the sender. The transfer of the access information can either be done automatically or manually. Communicating the guide access information to the receiver can be performed using email, SMS, or other electronic communication services, which may be provided by the system. However, the guide access information can also be communicated manually, for instance over the phone or printed on a paper.

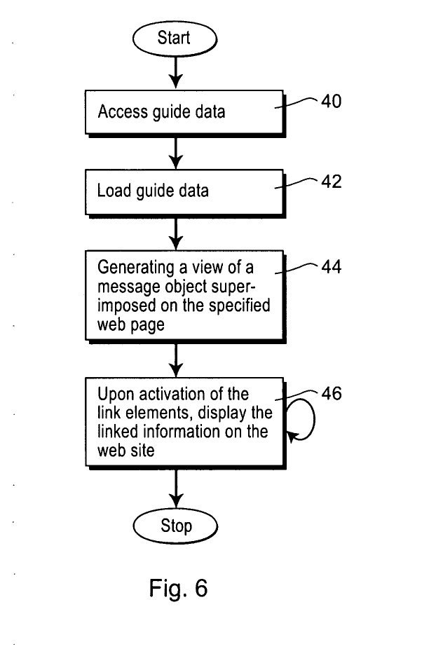

FIG. 6 is a flow chart showing what is happening when the receiver accesses the guide data. The receiver receives information on how to access the guide data. This information, for example, includes a code and an address, such as an URL, to the guide data. In this case, the receiver enters the address to the guide data in his web browser. Upon entering the address to the guide data, a graphical user interface is displayed to the receiver allowing the receiver to input a code. If a correct code is entered, guide data is loaded to the receiver computer device, block 42. Upon loading guide data, a website guide is displayed to the receiver. The website guide shows a graphical message object superimposed on the page of the website specified by the sender, block 44. The graphical message object includes link elements constituting links to the information selected by the sender. The receiver can then activate the link elements one by one, for example by clicking on them. When the receiver activates a link element, the selected web page with the selected information is displayed to the receiver, block 46. It is also possible for the sender to navigate on his own in the website, as it is the real website that is displayed on the screen. The graphical message object is superimposed on the presently displayed web page.

According to the invention, information on how to find selected information, in the following called guide content, is superimposed on an existing website. The system provided is able to superimpose the guide content on the website for the sender as well as for the receiver, when viewing the guide content. In order to do this, without making any adaptation to the existing website, this needs to be handled by changing the website in the web browser of the sender or receiver computer unit. The guide content adds to, or changes the content shown in the web browser. One-way to accomplish this is to add a floating layer of links on top of the website. In this case, the web browser is loading a web page that contains the website as an element inside the web page, making them appear as one.

A use of the invention is when a sales person is meeting with a customer at a trade fair and want to conclude the meeting with offer of a personalized summary of the relevant products by creating a guide of offers of particular relevance to the customer, to be viewed by the customer after the trade fair.

Another use of the system is a telephone sales where an offer is presented to a customer by means of a website guide, making that offer visible in a websites including a large set of offers.

A third use of the system is when a man and wife is looking at redecorating their house, and the husband want to show the wife two out of 20 different toilet seats on an online vendors.

A fourth use of the system is when a person wants to recommend a book to a friend, sending the recommendation as a message superimposed on an on-line bookstore where the friend may also purchase the book directly.

A fifth use is when a handling officer helps a citizen to complete an errand and wants to summarize a meeting by identifying the relevant forms and information on the authorities website in order to provide good service.

The present invention is not limited to the embodiments disclosed, but may be varied and modified within the scope of the following claims. For instance, the website server may act as a proxy, routing requests from and to the senders and receivers computers, while the guide server is still running on a different web server.

In another embodiment of the invention the guide database 4, the guide server 6, the guide access generator 7 and the communicating means 8 may all run on different computer software and hardware systems accessible over a network, such as the Internet. In another embodiment, the guide database 4 may be part of a website server 1a-c, while the guide server 2 is kept separate. Furthermore, in another embodiment of the invention, the guide data is stored as directly usable web pages enabling the use of the system without requiring a database management system. In yet another embodiment of the system, the website server 1a-c is configured to accept filed uploaded over the network, for instance by HTTP, FTP, or SFTP, enabling the use of the guides directly from the website server, without requiring any software installation in the website server.

In another embodiment, the “hide” button 15 is replaced or complemented with a drag and drop functionality, enabling the sender or the receiver to move the floating input object or the floating message object on the web page to ensure that the information on the web page can be viewed.

1. A method for creating a website guide for assisting in finding information on a website, the method comprising:
receiving an address specifying a page on the website;
generating a view showing a graphical input object superimposed on the specified page of the website allowing a first person to move around on the website and to enter links to selected information on the website;
receiving said links to the selected information on the website;
generating instructions on how to create a website guide in response to a request from a second person, showing a graphical message object superimposed on the specified page of the website, which graphical message object includes link elements which upon activation displays the selected information on the website;
storing guide data including the address to the specified page on the website, the links to the selected information, and said instructions on how to create a website guide; and
generating information on how to access the guide data in a format readable by a web browser.

2. The method according to claim 1, wherein said guide data is generated in a format readable by a web browser.

3. The method according to claim 1, wherein said view shows the graphical input object floating on top of the specified page, and said website guide shows said graphical message object floating on top of the specified page.

4. The method according to claim 1, wherein said view allows the first person to enter a link to a selected piece of information on a selected page on the website, the method further comprising:
generating upon activation of one of said link elements a third view showing the selected page of the website and a graphical highlighting object superimposed on the selected piece of information on the page.

5. The method according to claim 1, further comprising:
automatically communicating said information on how to access the guide data to said second person.

6. The method according to claim 1, wherein links to selected information on the website are entered to the graphical input object by a copy and past, or a drag and drop technique.

7. The method according to claim 1, wherein said information on how to access the guide data includes an address defining a web page containing the guide data.

8. The method according to claim 7, wherein said information on how to access the guide data includes a code to be input to an interactive object on the webpage in order to activate the object.

9. The method according to claim 1, further comprising:
including in said guide data input data entered by the first person to a selected page on the website; and
including a link element in said graphical message object, which link object upon activation automatically enters the input data to the selected web page.

10. A computer program product, comprising:
a computer readable medium; and
computer program instructions recorded on the computer readable medium and executable by a processor for performing a method comprising
receiving an address specifying a page on the website,
generating a view showing a graphical input object superimposed on the specified page of the website allowing a first person to move around on the website and to enter links to selected information on the website,
receiving said links to the selected information on the website,
generating instructions on how to create a website guide in response to a request from a second person, showing a graphical message object superimposed on the specified page of the website, which graphical message object includes link elements which upon activation displays the selected information on the website,
storing guide data including the address to the specified page on the website, the links to the selected information, and said instructions on how to create a website guide, and
generating information on how to access the guide data in a format readable by a web browser.

11. A system creating a website guide for assisting in finding information on a website, the system comprising:
a guide editor including information on how to generate a graphical user interface allowing a first person to specify a page on the website, and instructions on how to generate a view showing a graphical input object superimposed on the specified page on the website allowing the first person to enter links to selected information on the website;
a data storage for storing guide data including an address to the specified page on the website, links to the selected information, and instructions on how to create a website guide in response to a request from a second person, showing a graphical message object superimposed on the specified page of the website, which graphical message object includes link elements which upon activation displays the selected information on the website; and
an access generator generating information in a format readable by a web browser on how to access the stored guide data.

12. The system according to claim 12, wherein said view allows the first person to enter a link to a selected piece of information on a selected page on the website which is to be highlighted, and said website guide shows upon activation of one of said link elements a third view showing the selected page of the website and a graphical highlighting object superimposed on the selected piece of information on the page.

13. The system according to claim 12, further comprising:
communicating means adapted to automatically communicate said information on how to access the guide data to said second person.

14. The system according to claim 12, wherein said guide data includes input data entered by the first person on a selected page on the website, and said website guide shows a graphical message object including a link element, which upon activation automatically inputs the input data entered by the first person to the selected web page.

15. The system according to claim 12, further comprising:
a first server hosting the website; and
a second server hosting the guide editor and the data storage for storing guide data, wherein the first and second servers are separately arranged.

16. The system according to claim 12, further comprising:
a first computer device including a first graphical generator adapted to generate and display said graphical user interface and said view upon loading said guide editor; and
a second computer device including a web browser adapted to generate said website guide upon access of said guide data.
